(19) United States
(12) Patent Application Publication
(10) Pub. No.: US 2007/0157304 A1
(43) Pub. Date: Jul. 5, 2007

(54) Method, apparatus and computer program product for automatic cookie synchronization between distinct web browsers

(75) Inventors: Bryan Mark Logan, Rochester, MN (US); Timothy Charles Mossing, Rochester, MN (US)

Correspondence Address: IBM CORPORATION;ROCHESTER IP LAW DEPT 917, 3605 HIGHWAY 52 N, ROCHESTER, MN, 55901-7829, US

(73) Assignee: INTERNATIONAL BUSINESS MACHINES CORPORATION, ARMONK, NY (US)

(21) Appl. No.: 11/326,570

(22) Filed: Jan. 5, 2006

(51) Int. Cl. G06F 15/16

(52) U.S. Cl. 726/12

(57) ABSTRACT

A method, apparatus and computer program product are provided for implementing automatic cookie synchronization between distinct web browsers. A proxy server is used to allow a user to synchronize cookies for the user among a plurality of browsers. A user first authenticates to the proxy server, which could be a traditional user id/password login or a passive authentication based upon a static IP address of a client browser. The proxy server receives a HTTP request from a client browser and forwards the HTTP request to a web server. The proxy server receives a HTTP response from a Web server and forwards the HTTP response to the client browser. The proxy server monitors the HTTP request and response communications, and stores cookies locally to the proxy server. When the user switches from one browser to another browser, the cookies created for the first browser automatically transfer to the second browser.

### FIELD OF THE INVENTION

The present invention relates generally to the data processing field, and more particularly, relates to a method, apparatus and computer program product for implementing automatic cookie synchronization between distinct web browsers.

### Description of the Related Art

An HTTP cookie is a packet of information sent by a Web server to a browser and then sent back by the browser each time the browser accesses that Web server. The use of cookies allows Web sites to remember return users, improve the user experience by allowing users to bypass logins, remember user preferences, track user activity, and maintain states within the otherwise stateless HTTP protocol.

It is often frustrating to visit the very same Web site from different browsers, either from the same or different computers, and receive different Web site behaviors because there is a distinct cookie set respective to each browser being used.

Many Web browsers have the ability to import and export cookies for archival purposes, while it is often a substantially manual and tedious process to synchronize cookies with another browser on the same computer and even a more difficult process to synchronize cookies with a browser on different computer.

A user cannot simply switch from one browser to another and have the same set of cookies without performing a manual synchronization. Also, the synchronization software must support each browser and operating system being used, since each browser may store cookie information in a different manner.

A need exists for an effective mechanism to allow a user to use different Web browsers on the same or different computers and to automatically synchronize a set of cookies that correspond to the particular user, and solve this tedious cookie synchronization problem of prior art arrangements.

### SUMMARY OF THE INVENTION

Principal aspects of the present invention are to provide a method, apparatus and computer program product for implementing automatic cookie synchronization between distinct web browsers. Other important aspects of the present invention are to provide such method, apparatus and computer program product for implementing automatic cookie synchronization between distinct web browsers substantially without negative effect and that overcome many of the disadvantages of prior art arrangements.

In brief, a method, apparatus and computer program product are provided for implementing automatic cookie synchronization between distinct web browsers. A proxy server is used to allow a user to synchronize cookies for the user among a plurality of browsers. A user first authenticates to the proxy server, which could be a traditional user id/password login or a passive authentication based upon a static IP address of a client browser. The proxy server receives a HTTP request from a client browser and forwards the HTTP request to a web server. The proxy server receives a HTTP response from a Web server and forwards the HTTP response to the client browser. The proxy server monitors the HTTP request and response communications, and stores cookies locally to the proxy server. When the user switches from one browser to another browser, the cookies created for the first browser automatically transfer to the second browser.

In accordance with features of the invention, the proxy server can be a traditional proxy server or a transparent proxy server within a network device such as a router that all traffic has to flow through in order to get out to the Internet. The user can use different browsers that use the same set of cookies, and the user also is able to use different browsers on different computers that will use the same set of cookies. Given successful authentication to the proxy server, this mechanism allows the same user browsing from different computers at home, in the office, at a friend's house, and at the local Internet cafe, to use the same cookie set from each environment.

### BRIEF DESCRIPTION OF THE DRAWINGS

The present invention together with the above and other objects and advantages may best be understood from the following detailed description of the preferred embodiments of the invention illustrated in the drawings, wherein:

FIG. 1 is a block diagram illustrating an exemplary system for implementing automatic cookie synchronization between distinct web browsers of multiple authenticated devices in accordance with the preferred embodiment;

FIG. 2 is a block diagram illustrating another exemplary system for implementing automatic cookie synchronization between distinct web browsers on a same agent in accordance with the preferred embodiment;

FIG. 3 is a block diagram illustrating another exemplary system for implementing automatic cookie synchronization between distinct web browsers and forcing all cookies set by the server to be session-based in accordance with the preferred embodiment;

FIG. 4 is a flow diagram illustrating exemplary steps for implementing automatic cookie synchronization between distinct web browsers in accordance with the preferred embodiment; and

FIG. 5 is a block diagram illustrating a computer program product in accordance with the preferred embodiment.

### DETAILED DESCRIPTION OF THE PREFERRED EMBODIMENTS

In accordance with features of the invention, a cookie proxy method is used for allowing for an intermediary proxy server to monitor HTTP request and response communications and store cookies flowing through this intermediary to share and synchronize with other authenticated devices for a user. Before a cookie is inserted into an HTTP request, a response is sent back to the client with the cookie to give them a chance to accept or reject the cookie. This allows the client to also store the cookie on the browser system in case they change to a situation where they are not behind the proxy server. It also gives the client control to reject a cookie if the user so desires. The method provides the ability for a user to go to a certain synchronization page and have all the cookies synchronized from the proxy server to a device. This is useful when the user knows in advance that he will be unable to use the proxy server, for example, this could result when the user is away from the network, on a plane, and the like. The method provides the ability of the proxy server to force all cookies sent to the system to become a session-based cookie so the cookie information is stored for only the life of the session; that is while the Web browser is open. This feature is particularly useful when using a public terminal in a library, Internet cafe, and the like, where the user may have a general anxiety about stored cookies and user privacy.

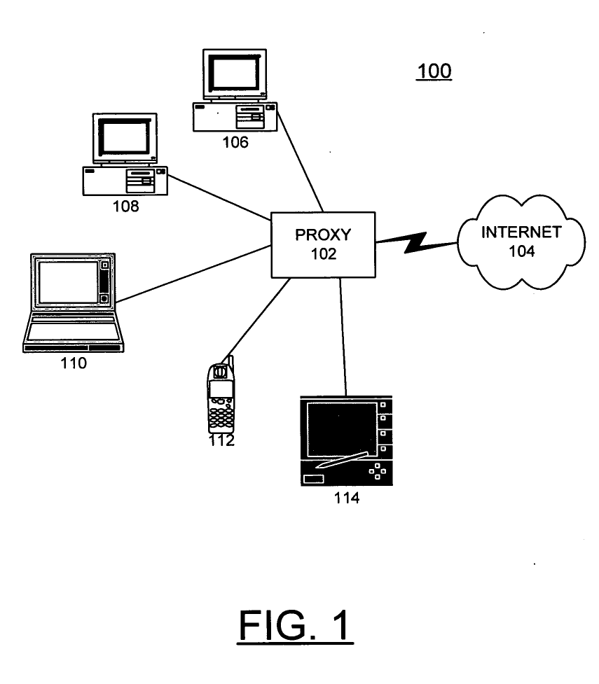

Having reference now to the drawings, in FIG. 1, there is shown an exemplary system for implementing automatic cookie synchronization between distinct web browsers of multiple authenticated devices generally designated by the reference character 100 in accordance with the preferred embodiment.

System 100 includes a proxy server 102 coupled between the Internet 104 and multiple client devices. Proxy server 102 is used to allow a user to synchronize cookies among a plurality of browsers, each within a particular client device. As shown is system 100, the browser-containing client devices include a first computer 106, a second computer 108, a notebook computer 110, a cellular telephone 112, and a server computer 114.

System 100 enables multiple authenticated devices to share an identical or the same cookie set that is cached on a proxy server 102. This feature is beneficial in home networks and also public laboratory settings.

In operation, a user first authenticates to the proxy server 102, which includes a traditional user id/password login or a passive authentication based upon a static IP address of a client browser. The proxy server 102 receives a HTTP request from a client browser and forwards the HTTP request. The proxy server 102 receives HTTP response from a Web site. The proxy server 102 monitors the HTTP request and response communication, and stores cookies locally to the proxy server 102. When the user switches from one browser to another browser, the cookies created by the first browser automatically transfer to the second browser.

In accordance with features of the invention, the proxy server can be a traditional proxy server or a transparent proxy server within a network device such as a router that all traffic has to flow through in order to get to the Internet. With a traditional proxy server implementing the proxy server 102, the proxy server is externally addressable over the Internet 104. A traditional proxy server 102 is specified in a browser configuration and a transparent proxy 102 is configured on the interface to a router or other network device in which it resides.

In accordance with features of the invention, the user can use multiple, different browsers that use the same set of cookies. The user also is able to use different browsers on different computers that will use the same set of cookies. Given successful authentication to the proxy server 102, the method implemented by proxy server 102 allows the same user browsing from different computers at home, in the office, at a friend's house, and at the local Internet cafe, to use the same cookie set from each environment.

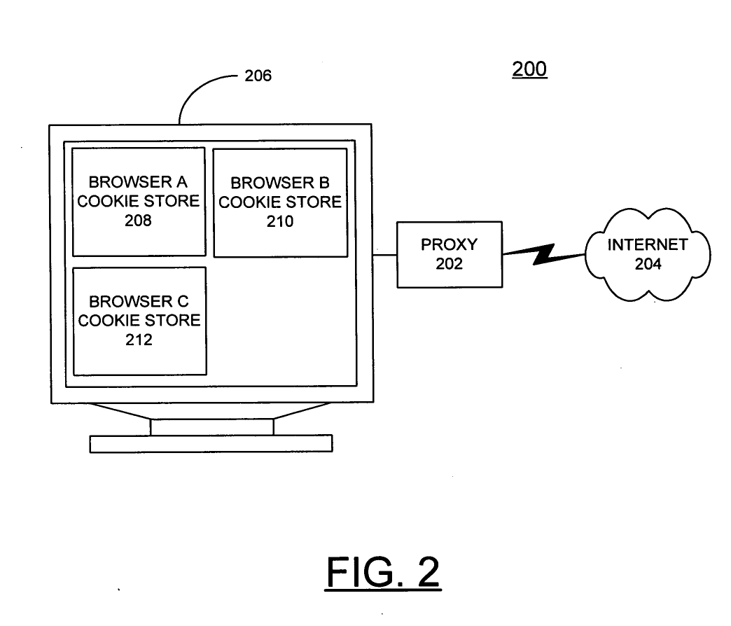

In FIG. 2, there is shown another exemplary system for implementing automatic cookie synchronization between distinct web browsers on a same agent generally designated by the reference character 200 in accordance with the preferred embodiment. System 200 includes a proxy server 202 coupled between the Internet 204 and a computer 206 containing multiple browsers 208, 210, 212. Proxy server 202 allows a user to synchronize cookies among the plurality of browsers 208, 210, 212 within the single client device 206. System 200 illustrates that the same cookie set can be shared between multiple agents can also be shared with distinct browsers 208, 210, 212 on the same agent.

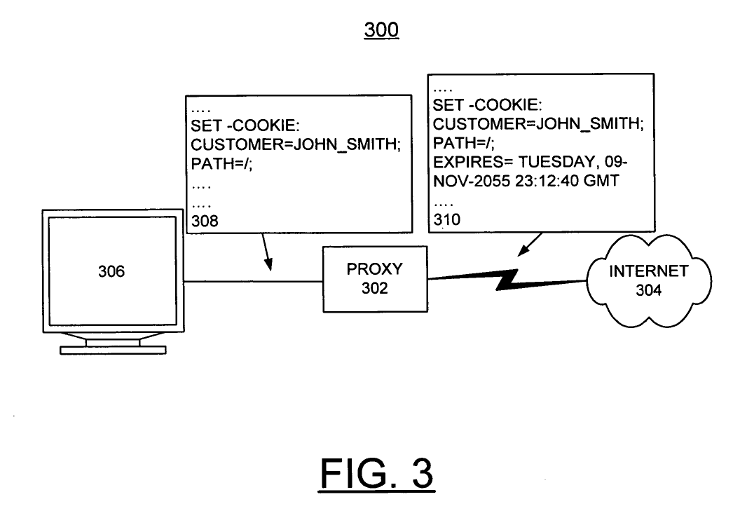

In FIG. 3 there is shown another exemplary system for implementing automatic cookie synchronization between distinct web browsers and for forcing all cookies set by the server to be session-based generally designated by the reference character 300 in accordance with the preferred embodiment. System 300 includes a proxy server 302 coupled between the Internet 304 and a computer 306, such as a public computer used by multiple users. As indicated in a block 308, a cookie is set identifying a user and a path. As indicated in a block 310, the cookie set identifying the user and path includes a time stamp setting the cookie to expire.

In system 300, HTTP cookies are set to expire at some time in the future or at the end of a session, typically, when the Web browser instance is closed. When using a public computer, a User A may not want cookies left on the computer 306 that would allow visited Web sites to later identify to a subsequent User B the previous user as User A. This would be especially bad if the cookie or cookies set by a certain Web site allowed a later user to bypass a login. A configurable option is available for users to indicate that all cookies being set are to expire on a per session basis. If this setting were turned on, the proxy server in use would modify the HTTP header for HTTP responses changing all non-session expiring cookies to expire on a session basis. When the user ends his browser session on the public computer, all traces of cookies set during his session will no longer be resident. All permanent cookies sent by a Web site are stored by the proxy server 302 as permanent cookies, but would never be sent back to the client 306 as permanent.

Although the proxy server 102, 202, 302 can be implemented by a traditional proxy server, a preferred embodiment the proxy server 102, 202, 302 is implemented by a transparent proxy within a network device such as a network router. By implementing the proxy server 102, 202, 302 in a generally inexpensive router, sharing cookies between PCs is enabled using that network router. Also, network hardware used in a laboratory settings, either public or private, are ideal candidates for this invention since users are rarely on the same machine, making the ability to share cookies particularly beneficial. Strengthening user privacy in the lab setting while enabling the ability to modify all cookies on a session-basis is also an advantage. Network router manufacturers would benefit from the use of and licensing the method of the invention since features are simple and inexpensive to implement and provide distinct differentiation in the network environment.

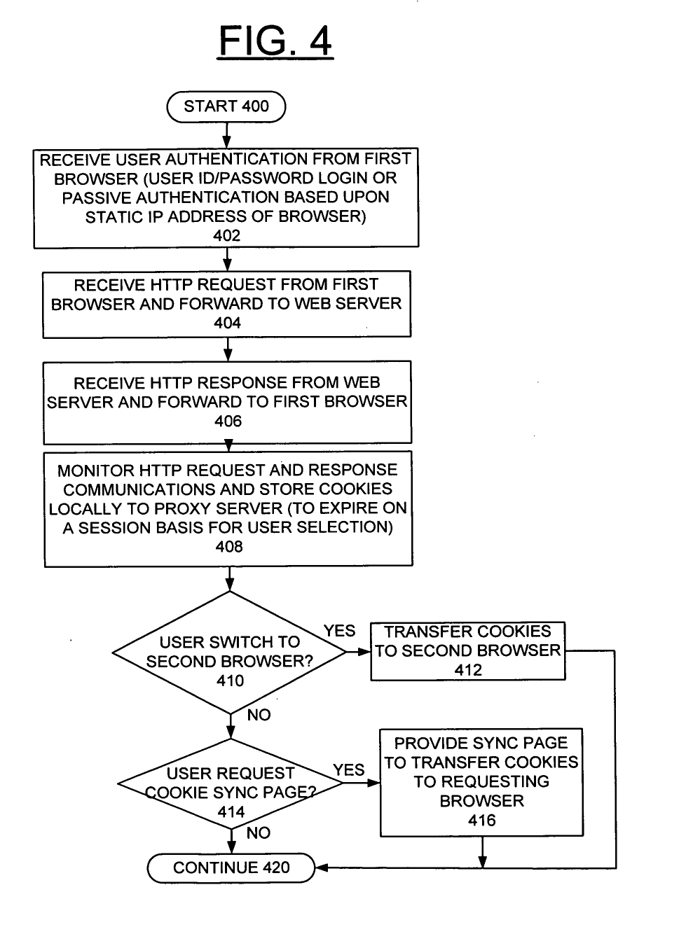

Referring to FIG. 4, there are shown exemplary steps for implementing automatic cookie synchronization between distinct web browsers in accordance with the preferred embodiment starting at a block 400. The proxy server 102, 202, 302 acts an intermediary between the client and a Web server. A user authentication is received by the proxy server from a first browser, such as, a traditional user id/password login or a passive authentication based upon a static IP address of a client browser, as indicated in a block 402. The proxy server receives the HTTP requests from the client browser and forwards these requests to the Web server as indicated in a block 404. Likewise, the proxy server receives the HTTP responses from the Web server and relays these responses to the browsing client as indicated in a block 406.

As indicated in a block 408, the proxy server monitors the HTTP request and response communications, and stores cookies locally to the proxy server. When a HTTP response comes back from a Web site that sets a cookie, the proxy server stores that cookie information. When a HTTP request goes out from a browser, the proxy will check the cookie information. If there is a cookie set in the request, this cookie is stored by the proxy server. If the proxy server has a cookie that applies to the website that is not set by the browser, it will generate an HTTP response to the browser that will direct the browser to set the cookie and re-request the page. The proxy server then remembers that it has attempted to synchronize the cookies for that certain request and waits for a response. When the subsequent HTTP request comes in from the client browser, the proxy forwards the request to the web site. These operations allow the user the option to reject certain cookies and not have the proxy server constantly trying to force the client browser to accept the cookies. Since no extra request is sent to the domain specified in the HTTP request, only extra local traffic is created between the client browser and the proxy. Session-based cookies are stored on the proxy server, but only for a limited time period, for example, five minutes after the last use of the cookie, so that if there were a problem with one browser using session-based cookies for a Web site, the user could switch to another browser and continue with what they were doing. The user can configure this time period after the last use of the cookie.

As indicated in a decision block 410, when a user switches to a different browser, then the cookies are transferred to the second browser as indicated in a block 412.

As indicated in a decision block 414, when a user request a cookie synchronization (sync) page, then the synchronization page is provided to transfer cookies to the requesting browser as indicated in a block 416 and the operations continue as indicated in a block 420. If the transparent proxy is being utilized and the user wanted to completely synchronize their cookies, the user is able to point the browser at the transparent proxy server and request the special cookie synchronization page. An example is when the user will be traveling on business and not be able to access the router running the transparent proxy server in his home office, the user may want to synchronize the stored cookies before leaving town. This synchronization page forces a series of HTTP requests/responses between the client and proxy server. The proxy server sends back an HTTP response to the client with cookie information set in the header for a given domain in addition to a HTTP redirect code to request the next site, which the proxy has cookies locally stored. This flow continues until the cookies stored on the proxy are synchronized with the requesting client. Any session-based cookies that happened to be stored on the proxy would not be synchronized. No external traffic, except for DNS lookups, would be generated to the outside sites. Also, the user could configure which computers and/or users behind the proxy server to be part of the same cookie set or cookie jar. This is done either by a static configuration in the proxy server or by having a user authenticate from each individual IP address.

To aid in the use of this invention, a browser can include an option, either built-in or via a plug-in, to let the user re-open the current page using a different browser or to open a link using a different browser. This would allow the user to easily switch browsers without having to copy and paste potentially long URL's. However, it should be understood that the presence of this feature is not required for use of this invention.

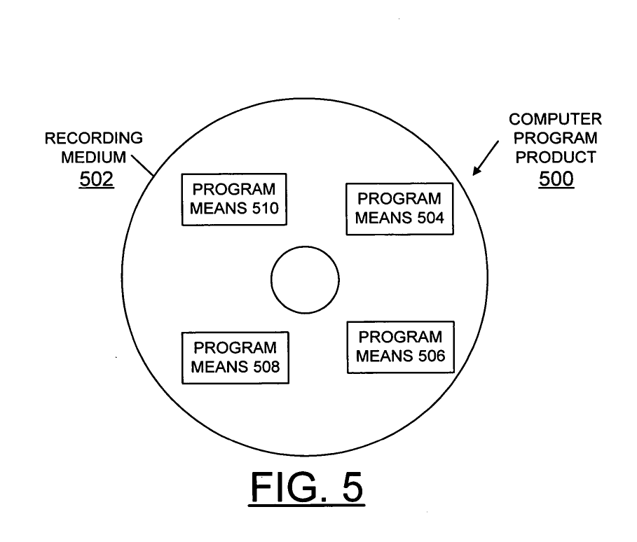

Referring now to FIG. 5, an article of manufacture or a computer program product 500 of the invention is illustrated. The computer program product 500 includes a recording medium 502, such as, a floppy disk, a high capacity read only memory in the form of an optically read compact disk or CD-ROM, a tape, a transmission type media such as a digital or analog communications link, or a similar computer program product. Recording medium 502 stores program means 504, 506, 508, 510 on the medium 502 for carrying out the methods for implementing automatic cookie synchronization between distinct web browsers of the preferred embodiment in the proxy server 102 of FIG. 1, proxy server 202 of FIG. 2, and proxy server 302 of FIG. 3.

A sequence of program instructions or a logical assembly of one or more interrelated modules defined by the recorded program means 504, 506, 508, 510, direct the proxy server 102, 202, 302 for implementing automatic cookie synchronization between distinct web browsers of the preferred embodiment.

Embodiments of the present invention may also be delivered as part of a service engagement with a client corporation, nonprofit organization, government entity, internal organizational structure, or the like. Aspects of these embodiments may include configuring a computer system to perform, and deploying software, hardware, and web services that implement, some or all of the methods described herein. Aspects of these embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems.

While the present invention has been described with reference to the details of the embodiments of the invention shown in the drawing, these details are not intended to limit the scope of the invention as claimed in the appended claims.

What is claimed is:

1. A method for implementing automatic cookie synchronization for a user between a plurality of browsers, said method performed by a proxy server comprising:
receiving a user authentication to the proxy server;
receiving a HTTP request from a first client browser and forwarding the HTTP request to a web server;
receiving a HTTP response from a Web server and forwarding the HTTP response to the first client browser;
monitoring the HTTP request and response communications, and storing cookies locally to the proxy server; and
automatically transferring cookies created for the first browser to a second browser responsive to the user switching from the first browser to the second browser.

2. A method for implementing automatic cookie synchronization as recited in claim 1 wherein receiving a user authentication includes identifying a user identification in a password login.

3. A method for implementing automatic cookie synchronization as recited in claim 1 wherein receiving a user authentication includes receiving a passive authentication based upon a static IP address of a client browser.

4. A method for implementing automatic cookie synchronization as recited in claim 1 includes receiving a user request of cookie synchronization page, and transferring stored cookies to a requesting browser.

5. A method for implementing automatic cookie synchronization as recited in claim 1 includes receiving a user request for cookies to expire on a session basis; and changing all cookies to expire on a session basis.

6. A computer program product for implementing automatic cookie synchronization for a user between a plurality of browsers, said computer program product including instructions executed by a proxy server to cause the proxy server to perform the steps comprising:
receiving a user authentication to the proxy server;
receiving a HTTP request from a first client browser and forwarding the HTTP request to a web server;
receiving a HTTP response from a Web server and forwarding the HTTP response to the first client browser;
monitoring the HTTP request and response communications, and storing cookies locally to the proxy server; and
automatically transferring cookies created for the first browser to a second browser responsive to the user switching from the first browser to the second browser.

7. A computer program product for implementing automatic cookie synchronization as recited in claim 6 further comprises receiving a user request for cookies to expire on a session basis; and changing all cookies to expire on a session basis.

8. A computer program product for implementing automatic cookie synchronization as recited in claim 6 wherein receiving a user authentication includes identifying a user identification in a password login.

9. A computer program product for implementing automatic cookie synchronization as recited in claim 6 wherein receiving a user authentication includes receiving a passive authentication based upon a static IP address of a client browser.

10. A computer program product for implementing automatic cookie synchronization as recited in claim 6 further comprises receiving a user request of cookie synchronization page, and transferring stored cookies to a requesting browser.

11. Apparatus for implementing automatic cookie synchronization for a user between a plurality of browsers comprising:
a proxy server for receiving a user authentication from one of the browsers;
said proxy server for receiving a HTTP request from a first client browser and for forwarding the HTTP request to a web server;
said proxy server for receiving a HTTP response from a Web server and forwarding the HTTP response to the first client browser;
said proxy server for monitoring the HTTP request and response communications, and for storing cookies locally to the proxy server; and
said proxy server for automatically transferring cookies stored for the first browser to a second browser responsive to the user switching from the first browser to the second browser.

12. Apparatus for implementing automatic cookie synchronization as recited in claim 11 wherein said proxy server, responsive to receiving a user request of cookie synchronization page, transfers stored cookies to a requesting browser.

13. Apparatus for implementing automatic cookie synchronization as recited in claim 11 wherein said proxy server, responsive to receiving a user request for cookies to expire on a session basis; changes cookies to expire on a session basis.

14. Apparatus for implementing automatic cookie synchronization as recited in claim 11 wherein a user authentication includes said proxy server identifying a user identification in a password login.

15. Apparatus for implementing automatic cookie synchronization as recited in claim 11 wherein a user authentication includes said proxy server receiving a passive authentication based upon a static IP address of a client browser.
